(19) United States
(12) Patent Application Publication
(10) Pub. No.: US 2026/0167034 A1
(43) Pub. Date: Jun. 18, 2026

(54) DOCKING AND CHARGING STATION

(71) Applicants: Hyundai Motor Company, Seoul (KR); Kia Corporation, Seoul (KR)

(72) Inventors: Dae Young GWON, Hwaseong-si (KR); Ji Hyun SONG, Hwaseong-si (KR)

(73) Assignees: Hyundai Motor Company, Seoul (KR); Kia Corporation, Seoul (KR)

(21) Appl. No.: 19/225,674

(22) Filed: Jun. 2, 2025

(30) Foreign Application Priority Data
Dec. 16, 2024 (KR) 10-2024-0187449

(51) Int. Cl. B60L 53/36; B60L 53/65

(52) U.S. Cl. CPC B60L 53/36; B60L 53/65

(57) ABSTRACT

A docking and charging station reduces the inconvenience of waiting for charging by determining station usage authorization through a pre-authentication process before charging the electric mobility vehicle, allows easy access to the charging location, automatically aligns the charging position, eliminating the need for manually positioning the mobility vehicle, and ensures charging convenience by automating both power charging and fluid supply.

### CROSS REFERENCE TO RELATED APPLICATION

The present application claims priority to Korean Patent Application No. 10-2024-0187449, filed Dec. 16, 2024, the entire contents of which is incorporated herein for all purposes by this reference.

### BACKGROUND

### Technical Field

The present disclosure relates to a docking and charging station that enhances the charging convenience of electric vehicles by automatically aligning the charging position for electric mobility vehicle.

### Description of the Related Art

Charging infrastructure technology for electric mobility vehicle addresses the technical challenges involved in building and operating charging systems to meet the growing demand for electric mobility vehicle.

Key areas requiring continuous improvement in infrastructure development include reducing charging time and enhancing convenience.

However, charging electric mobility vehicle typically requires users to exit the vehicle and manually connect the charger to the electric mobility vehicle.

Additionally, even after moving the vehicle to a charging station, users may precisely align its position, as charging can only proceed when the vehicle is adjacent to the charger at the designated parking spot.

As a result, the need for users to repeatedly enter and exit the vehicle and carefully position it at the charging spot reduces the convenience of charging electric mobility vehicle.

The related art described above is intended merely to aid in the understanding of the background of the disclosure, and should not be construed as recognizing the prior art which is known to those skilled in the art.

### SUMMARY

The present disclosure has been conceived to solve the above problems and it is an object of the disclosure to provide a docking and charging station that facilitates easy access to the charging location for electric mobility vehicle, automatically aligns the vehicle for charging, and automates both power charging and fluid supply, enhancing the convenience of charging electric mobility vehicle.

The technical objects of the disclosure are not limited to the aforesaid, and other objects not described herein with be clearly understood by those skilled in the art from the descriptions below.

To accomplish the above objects, a docking and charging station of the disclosure includes a detector configured to detect a mobility vehicle entering a charging area, a securing means disposed in the charging area and configured to adjust the position of the mobility vehicle detected by the detector to a charging position upon the mobility vehicle entering the charging area, and a charger disposed to be movable within the charging area and configured, upon moving to the charging position, to dock with the mobility vehicle adjusted in position by the securing means to provide at least one of power or fluid to the mobility vehicle or to exchange with the mobility vehicle.

The detector is configured to collect at least one of authentication status information, battery information, and status information of the mobility vehicle.

The securing means includes a support plate rotatably disposed on the floor of the charging area and configured to accommodate the mobility vehicle.

The support plate includes a contact portion disposed at the center portion thereof, and the mobility vehicle includes a connection portion disposed at a lower portion thereof and configured to contact with the contact portion, and upon the mobility vehicle entering the support plate, be guided by contacting with the contact portion to align the mobility vehicle to the center portion of the support plate.

The connection portion extends from an edge portion toward the center portion on the bottom portion of the mobility vehicle with a gradually narrowing width, and upon the mobility vehicle entering the support plate, comes into contact with the contact portion, guiding the mobility vehicle to the center portion of the support plate.

The mobility vehicle includes a door disposed at the entrance of the connection portion, the door being configured to open upon the mobility vehicle entering the securing means.

The mobility vehicle detects the position of the contact portion via a sensor and moves to enter the securing means, with the connection portion facing toward the contact portion.

The charging area includes a structure disposed with a supply module configured to provide or exchange at least one of power or fluid, and the charger is movably disposed on the structure.

The charger includes a movable member and a docking member, the movable member having a variable length through a sliding motion within the structure, and the docking member being connected to the movable member and moving therewith, the docking member being disposed with a connector configured to dock with the mobility vehicle while moving to the charging position.

The charging area includes a guide rail disposed on the floor thereof, and the docking member is seated on the guide rail and moves along the guide rail.

The movable member is provided in plural and provided to move within the structure, with the spacing between the movable members being adjustable, and the docking member is connected to the plurality of movable members, with each movable member having a variable length in the direction of movement.

The connector is adjustable in position in multiple directions on the docking member.

The docking member includes a jig part configured to contact and support the exterior of the mobility vehicle moving to the charging position.

The charger is connected to the supply module to deliver at least one of power or fluid, and further includes a supply line extending along the movable member and docking member to connect with the connector.

The supply line includes a power supply line including a fixed line and a movable line, the fixed line being disposed to extend from the structure to the movable member, the movable line being disposed to move with the docking member, and the fixed line and movable line being grounded at the movable member to transmit power via wireless power transfer or sliding contact.

The movable member includes a fixed portion disposed on the structure and a sliding portion slidably connected to the fixed portion, with the docking member being connected to the sliding portion, and the fixed portion includes a driving portion connected to the sliding portion to move the sliding portion.

The docking member includes a sensor configured to detect the distance between the docking member and the mobility vehicle entering the charging area, and the driving portion adjusts the movement distance of the sliding portion based on the distance between the docking member and the mobility vehicle, as input thereof by the sensor.

The docking and charging station further includes a controller configured to control the securing means and the charger, wherein the controller communicates with the mobility vehicle to provide authenticated mobility vehicle information to the detector, and the detector verifies the authenticated mobility vehicle based on the provided information.

The controller is configured to control the securing means to adjust the position of the mobility vehicle to the charging position upon the mobility vehicle entering the securing means, and communicates with the mobility vehicle to control the mobility vehicle to remain stationary.

The controller is configured to control the charger to move out of the charging position when a passenger enters or exits the mobility vehicle.

The included docking and charging station is advantageous in terms of eliminating the inconvenience of waiting for charging by requiring users to undergo a pre-authorization process before gaining access to the station.

Furthermore, the docking and charging station is advantageous in terms of eliminating the inconvenience of having to precisely move the electric mobility vehicle to the charging spot, thanks to easy access to the charging location and automatic alignment of the charging position of the electric mobility vehicle.

Furthermore, the docking and charging station is advantageous in terms of ensuring the convenience of charging electric mobility vehicle through the automation of both power charging and fluid supply.

The advantages of the disclosure are not limited to the aforesaid, and other advantages not described herein may be clearly understood by those skilled in the art from the descriptions below.

### BRIEF DESCRIPTION OF THE DRAWINGS

FIG. 1 is a diagram illustrating a docking and charging station according to an exemplary embodiment of the present disclosure;

FIG. 2 is a diagram illustrating a mobility vehicle before entering the securing means of the docking and charging station shown in FIG. 1;

FIG. 3 is a diagram illustrating the mobility vehicle after entering the securing means of the docking and charging station shown in FIG. 1;

FIG. 4 is a diagram illustrating the mobility vehicle aligned by the securing means in the docking and charging station shown in FIG. 1;

FIG. 5 is a diagram illustrating the mobility vehicle according to an exemplary embodiment of the present disclosure;

FIG. 6 diagram illustrating the mobility vehicle docked to a charger of the present disclosure;

FIG. 7 is a diagram illustrating the charger according to an exemplary embodiment of the present disclosure;

FIG. 8 is a diagram illustrating the charger according to another embodiment of the present disclosure;

FIG. 9 is a diagram illustrating the docking and charging station according to another embodiment of the present disclosure;

FIG. 10 is a flowchart illustrating the control sequence of the docking and charging station according to the present disclosure;

FIG. 11 is a diagram illustrating a mobility vehicle before entering the docking and charging station according to the present disclosure;

FIG. 12 is a diagram illustrating a mobility vehicle aligned by the securing means of the docking and charging station according to the present disclosure; and

FIG. 13 is a diagram illustrating a mobility vehicle docked to the charger of the docking and charging station according to the present disclosure.

### DETAILED DESCRIPTION

Detailed descriptions of known technologies may be omitted to avoid obscuring the subject matter of the embodiments disclosed in this specification. Additionally, the accompanying drawings are provided to facilitate understanding of the embodiments disclosed in this specification, but the technical idea disclosed in this specification is not limited by the accompanying drawings, and all changes, equivalents, or substitutes included in the scope of the idea and technology of this disclosure should be understood to be included.

As used herein, terms including an ordinal number such as “first” and “second” can be used to describe various components without limiting the components. The terms are used only for distinguishing one component from another component.

The singular forms are intended to include the plural forms as well unless the context clearly indicates otherwise.

In the specification, terms such as “comprising” or “having” indicate the presence of the features, numbers, steps, operations, components, or parts listed in the specification, without excluding the presence or possibility of one or more other features, numbers, steps, operations, components, or parts or their combinations.

As used in the following description, the suffix “module” and “unit” are granted or used interchangeably in consideration of easiness of description but, by itself, having no distinct meaning or role.

It will be understood that when a component is referred to as being “connected to” or “coupled to” another component, it can be directly connected or coupled to the other component or intervening component may be present. In contrast, when a component is referred to as being “directly connected to” or “directly coupled to” another component, there are no intervening component present.

Furthermore, it should be noted that the terms ‘unit’ or ‘control unit’ used in the names of components typically refer to controllers responsible for specific vehicle functions, rather than indicating a generic function unit.

For example, each controller may include a communication device communicating with another controller or sensor to control a function in charge, a memory that stores operating system or logic instructions and input/output information, and one or more processors for determination, operation, and decision-making necessary for functions in charge.

Any of the configurations described herein may include any number or variety of components within the scope of the disclosure. Components may include any combination of the features described herein and may be arranged in any of the various configurations described herein. The concepts regarding the structure and arrangement of the components of the present disclosure, as well as their use and operation, can be applied not only to the specific embodiments discussed in the present specification but also to any number of embodiments with various combinations. Hereinafter, embodiments that include various features with different arrangements are described with reference to the accompanying drawings.

The following provides a detailed description of the embodiments disclosed in the present specification with reference to the accompanying drawings, using identical reference numerals for identical or similar components to avoid redundancy.

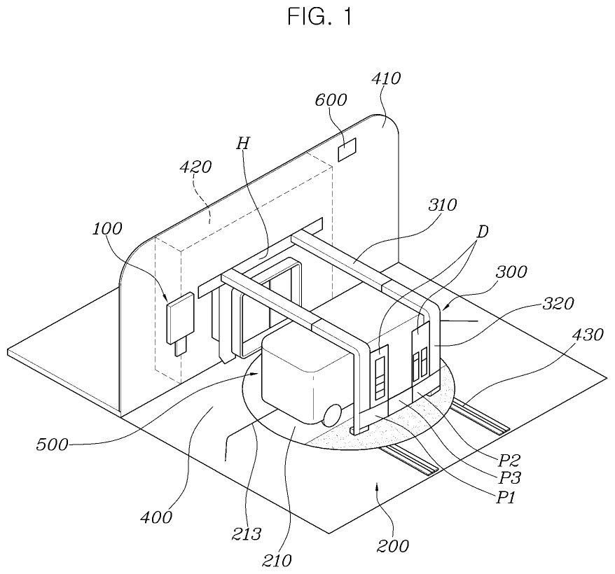

FIG. 1 is a diagram illustrating the docking and charging station according to an exemplary embodiment of the present disclosure, showing the mobility vehicle 500 entering the securing means 200 and charger 300.

The docking and charging station according to the disclosure includes, as shown in FIG. 1, a detector 100 for detecting the mobility vehicle 500 entering the charging area 400, a securing means 200 disposed in the charging area 400 to adjust the position of the mobility vehicle 500 to the charging position when the mobility vehicle 500, detected by the detector 100, enters the charging area 400, and a charger 300, moveably disposed in the charging area 400, that docks with the mobility vehicle 500, whose position is adjusted by the securing means 200 when moved to the charging position, to provide at least one of power or fluid to the mobility vehicle 500 or exchange these with the mobility vehicle 500.

The charging area 400 is a space where the mobility vehicle 500 may be parked, and includes the securing means 200 and the charger 300. This charging area 400 may be configured to accommodate mobility vehicle 500 of various sizes and may be disposed to either provide parking spaces or connect to roads.

The detector 100 detects the mobility vehicle 500 entering the charging area 400. This detector 100 may include at least one of a camera, laser, infrared, or communication device, and may be a variety of means configured for verifying information related to the mobility vehicle 500, such as its license plate or a device carried by a user inside the mobility vehicle 500. The information obtained through the detector 100 is sent to a server or controller in a building disposed with the securing means 200 and the charger 300 to determine whether the mobility vehicle 500 is allowed to enter.

By detecting the mobility vehicle 500 entering the charging area 400 through the detector 100, entry may be permitted when the mobility vehicle 500 is authenticated. Authentication of the mobility vehicle 500 may be performed through a device carried by the user onboard the mobility vehicle 500 or by verifying the authentication status of the mobility vehicle 500 itself.

Meanwhile, the securing means 200, disposed in the charging area 400, is configured to adjust the position of the mobility vehicle 500 entered the charging area 400 to the charging position. The charging position is the location in the charging area 400 where the mobility vehicle 500 may dock with the charger 300.

The securing means 200 may be disposed on the floor of the charging area 400, and the mobility vehicle 500 that enters the charging area 400 is seated in the securing means 200. The securing means 200 may adjust the position of the mobility vehicle 500 to a chargeable position through rotational or lifting movements. As a result, when the mobility vehicle 500 enters the charging area 400, the securing means 200 automatically aligns the mobility vehicle 500 to a position suitable for charging, eliminating the need for manual position adjustment.

The charger 300 docks with the mobility vehicle 500 aligned to the charging position in the charging area 400 and provides at least one of power or fluid. The present charger 300 may be designed to be moveable within the charging area 400, and because the mobility vehicle 500 is already aligned to the charging position by the securing means 200, the range of movement required for the charger 300 to dock with the mobility vehicle 500 may be minimized. In other words, the charger 300 may dock with the mobility vehicle 500 simply by moving in a straight line toward the mobility vehicle 500, as the mobility vehicle 500 has been aligned to the charging position by the securing means 200.

Meanwhile, the charger 300 may provide or exchange at least one of power or fluid with the mobility vehicle 500 when docking. For example, when providing power, the charger 300 may charge the battery of the mobility vehicle 500, or when supplying fluid, the fluid may be coolant or potable water. Here, the charger 300 may supply potable water to be used inside the mobility vehicle 500 or receive and treat wastewater already used in the mobility vehicle 500.

In the present way, the disclosure allows the detector 100 to detect the mobility vehicle 500 entering the charging area 400, and when the detected mobility vehicle 500 enters, the securing means 200 automatically aligns the mobility vehicle to the charging position, enabling the charger 300 to dock with the mobility vehicle 500 and perform the exchange of power or fluid.

Thus, the disclosure automates the alignment of the mobility vehicle 500 to the charging position and the supply of power or fluid to the mobility vehicle 500, ensuring the convenience of charging the mobility vehicle 500 and improving user satisfaction with the station.

A detailed description of the aforementioned embodiment of the disclosure is provided below.

The detector 100 may collect at least one of data related to the authentication status of the mobility vehicle 500, battery information, and mobility vehicle status information.

The detector 100 may include at least one of a camera, laser, infrared, or communication device, and may include various means to detect the mobility vehicle 500 or communicate with the mobility vehicle 500.

For example, the detector 100 may communicate with the mobility vehicle 500 entering the charging area 400 to verify whether the mobility vehicle 500 has made a payment for charging services before entering the charging area 400, and may allow the mobility vehicle 500 to enter the designated charging area 400.

Additionally, the detector 100 may verify the number plate of the mobility vehicle 500 entering the charging area 400 for authentication or communicate with a device carried by the user inside the mobility vehicle 500 to perform an authentication procedure.

In the present way, the detector 100 may perform the authentication procedure to determine whether the mobility vehicle 500 is allowed to enter the charging area 400 and may enable various services, including charging, based on the battery information and status information of the mobility vehicle 500.

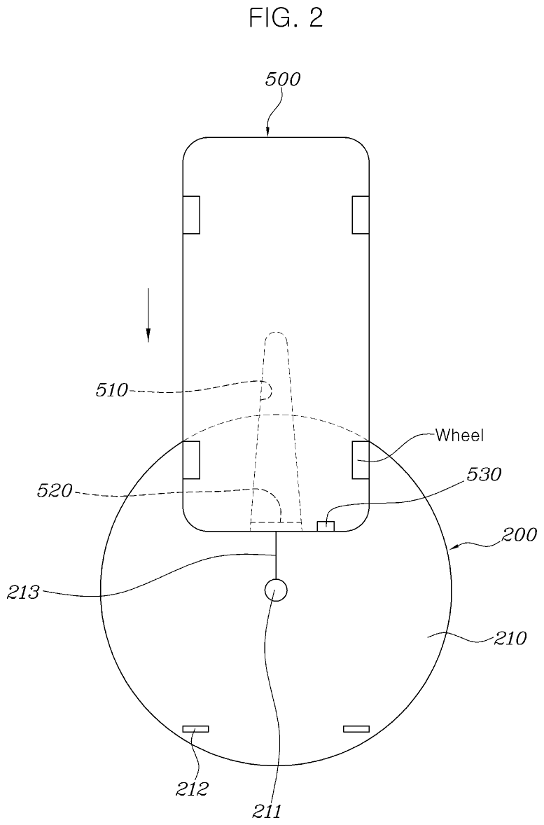

FIGS. 2 to 4 illustrate the adjustment of the mobility vehicle 500 to the charging position by the securing means 200.

The securing means 200 includes a support plate 210 which is rotatably disposed on the floor of the charging area 400 and is formed to support the mobility vehicle 500.

The support plate 210 may be circular in shape and formed greater than the mobility vehicle 500 to ensure the mobility vehicle 500 may be seated thereon. For example, a circular groove or hole is formed on the floor of the charging area 400, and the support plate 210 is disposed to cover the groove or hole, with its external edge portion seated in a slidable manner on the floor around the groove or hole, allowing the rotational position to be adjusted by a motor or actuator. Here, the motor or actuator includes a rotation shaft connected to the center portion of the support plate 210, allowing the support plate 210 to rotate. The motor or actuator for rotating the support plate 210 is one example of transmitting rotational power and is not limited to the present configuration.

Through this, when the mobility vehicle 500 enters the charging area 400 and settles onto the support plate 210, the parked position may change due to the rotation of the support plate 210.

Additionally, the support plate 210 may include a support ledge 212 where the wheels of the mobility vehicle 500 may rest upon entry, allowing the wheels of the mobility vehicle 500 to be securely positioned on the support ledge 212, stabilizing the position of the mobility vehicle 500.

Meanwhile, a contact portion 211 is disposed at the center portion of the support plate 210, and a connection portion 510, which contacts with the contact portion 211, is disposed on the underside of the mobility vehicle 500 so that when the mobility vehicle 500 enters the support plate 210, the connection portion 510 contacts with the contact portion 211 and is guided, aligning the mobility vehicle 500 to the center portion of the support plate 210.

The contact portion 211 may be formed to protrude upwards from the surface of the support plate 210, or in another embodiment, the contact portion 211 may be configured to be selectively extended or retracted. For example, the contact portion 211 may be configured to selectively protrude from the support plate 210 through an actuator unit. This allows the contact portion 211 to normally be retracted into the support plate 210 and not exposed, but when the mobility vehicle 500 enters the charging area 400, the contact portion 211 protrudes from the support plate 210 and contacts with the connection portion 510 of the mobility vehicle 500.

By positioning the contact portion 211 at the center portion of the support plate 210, the connection portion 510 of the mobility vehicle 500 may be guided to move toward the center portion of the support plate 210 in alignment with the position of the contact portion 211.

The connection portion 510 is formed on the bottom portion of the mobility vehicle 500, and as the mobility vehicle 500 enters the charging area 400, the connection portion 510 comes into contact with the contact portion 211, guiding the movement of the mobility vehicle 500. The connection portion 510 may be formed in a form of a slit extending along the travel direction on the bottom portion of the mobility vehicle 500, and as the mobility vehicle 500 enters the charging area 400, the contact portion 211 is inserted into the inside of the connection portion 510, guiding the movement of the connection portion 510, allowing the mobility vehicle 500 to move to the center portion of the support plate 210 where the contact portion 211 is formed, and be fixed in position.

In detail, the connection portion 510 extends from the edge portion toward the center portion of the bottom portion of the mobility vehicle 500, with its width gradually narrowing so that when the mobility vehicle 500 enters the support plate 210, the contact portion 211 contacts with the connection portion 510 and guides the mobility vehicle 500 to the center portion of the support plate 210.

The connection portion 510 is formed on the bottom portion of the mobility vehicle 500 and extends from the edge portion toward the center. For example, the connection portion 510 may extend from the front, which is the travel direction of the mobility vehicle 500, toward the center, and may be formed in the shape of a slit to allow the contact portion 211 to be inserted. The connection portion 510 is formed wider at the entrance than the contact portion 211, allowing the contact portion 211 to be inserted into the inside of the connection portion 510 when the mobility vehicle 500 enters the charging area 400. The connection portion 510 gradually narrows toward the center portion of the mobility vehicle 500 so that as the mobility vehicle 500 enters the charging area 400, the contact portion 211 contacts with the inside of the connection portion 510, guiding the movement of the mobility vehicle 500, and ultimately, the contact portion 211 is inserted into the end portion of the connection portion 510, restricting the movement of the mobility vehicle 500.

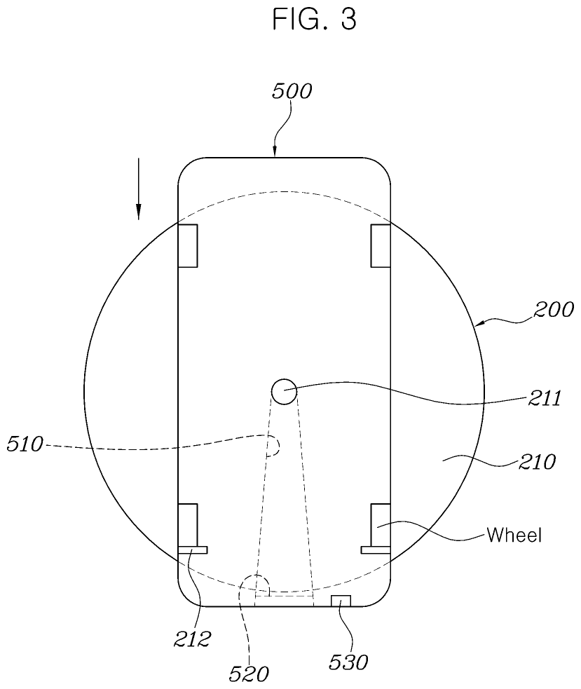

As shown in FIGS. 2 and 3, when the mobility vehicle 500 enters the support plate 210, the movement of the connection portion 510 is guided by the contact portion 211, and as the contact portion 211 moves toward the end portion of the connection portion 510, the mobility vehicle 500 is moved to the center portion of the support plate 210, which is the charging position. In the present way, by simply entering the charging area 400, the mobility vehicle 500 may be aligned to the center portion of the support plate 210, which is the charging position, and may settle on the support plate 210.

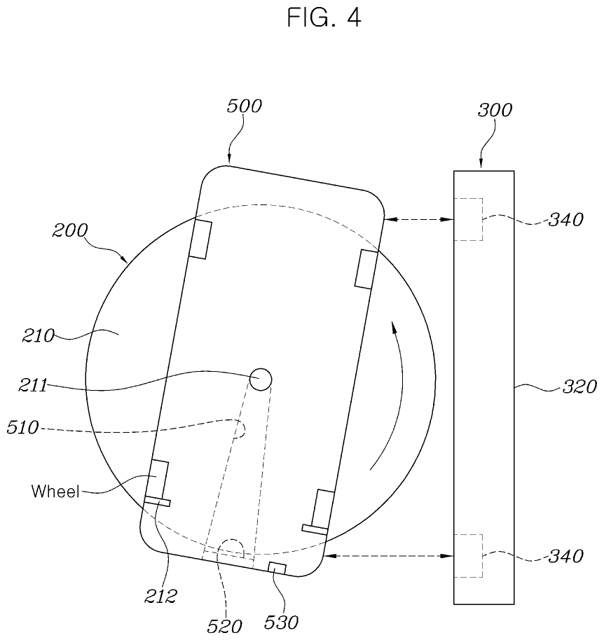

As shown in FIG. 4, while the mobility vehicle 500 is positioned on the support plate 210, the support plate 210 may rotate to align the position of the mobility vehicle 500 and dock the mobility vehicle 500 with the charger 300. That is, when the mobility vehicle 500 is positioned at the center portion of the support plate 210, the rotation of the support plate 210 may align the charging terminal (A) on the mobility vehicle 500 with the charger 300, ensuring they face each other.

As a result, when the mobility vehicle 500 enters the charging area 400, the connection portion 510 of the mobility vehicle 500 contacts with the contact portion 211, causing the mobility vehicle 500 to move and align to the center portion of the support plate 210, and once positioned at the center, the rotation of the support plate 210 may align the mobility vehicle 500 with the charger 300 for docking. In the present way, the position alignment for charging the mobility vehicle 500 is automated, ensuring convenient charging.

Meanwhile, the mobility vehicle 500 includes a door 520 at the entrance of the connection portion 510, and the door 520 may open when the mobility vehicle 500 enters the securing means 200.

Referring to FIG. 2, the door 520 is disposed at the entrance of the connection portion 510 on the mobility vehicle 500 and operates to open or close. The door 520 may be configured to open or close in a rotary or sliding manner at the entrance of the connection portion 510, with the opening and closing positions switched by motor or actuator control.

Under normal circumstances, the door 520 remains closed to prevent any obstacles other than the contact portion 211 from entering the connection portion 510 of the mobility vehicle 500, and when the mobility vehicle 500 enters the charging area 400, the door 520 opens to allow the contact portion 211 to enter.

The door 520 may be selectively opened or closed based on user approval or may be configured to open or close automatically via communication when the mobility vehicle 500 enters the charging area 400.

As shown in FIG. 2, the mobility vehicle 500 may be disposed with a sensor 530. The present sensor 530 may include at least one of a camera, infrared, laser, or LiDAR, and any means configured for detecting objects in the travel direction of the mobility vehicle 500 may be applied, without being limited to the specific embodiments.

Through this, when the mobility vehicle 500 enters the securing means 200, the sensor 530 may be configured to determine the position of the contact portion 211, and the mobility vehicle 500 may be configured for controlling its travel direction to align the connection portion 510 toward the contact portion 211.

In other words, when the mobility vehicle 500 moves toward the charging area 400, the sensor 530 checks the support plate 210 of the securing means 200, identifies the position of the contact portion 211 formed on the support plate 210, and adjusts the movement of the mobility vehicle 500 so that the connection portion 510 faces the contact portion 211. When the mobility vehicle 500 enters the charging area 400, the connection portion 510 may be automatically driven to face the contact portion 211.

As shown in FIGS. 2 and 3, the support plate 210 may further include a guideline 213 for guiding the entry direction of the mobility vehicle 500 so that the sensor 530 of the mobility vehicle 500 detects the guideline 213, and the mobility vehicle 500 moves along the guideline 213, being guided to a position on the support plate 210 where the mobility vehicle 500 may be charged.

As a result, when the mobility vehicle 500 enters the charging area 400, the mobility vehicle 500 autonomously drives to ensure that the connection portion 510 contacts with the contact portion 211, without the user directly controlling the mobility vehicle 500, and the position of the mobility vehicle 500 entering the support plate 210 is automatically aligned to the charging position, ensuring the convenience of charging the mobility vehicle 500.

Meanwhile, the charging area 400 includes a structure 410 disposed with a supply module 420 for supplying or exchanging at least one of power or fluid, and the charger 300 may be movably disposed in the structure 410.

The structure 410 may be a building, and the structure 410 includes the supply module 420 for supplying power or fluid. The supply module 420 may provide power to charge the battery of the mobility vehicle 500, supply coolant, drinking water, etc., or receive and treat wastewater from the mobility vehicle 500. The present supply module 420 may include a battery system for power storage and supply, as well as pump systems for the exchange of coolant, drinking water, and wastewater. Accordingly, the supply module 420 may include large-capacity power charging facilities or power generation facilities for power storage and supply, cooling water supply facilities for coolant, water purification facilities for drinking water, and wastewater treatment facilities for processing wastewater.

The charger 300 is disposed to be movable within the structure 410 and may dock with the mobility vehicle 500 that has entered the charging area 400.

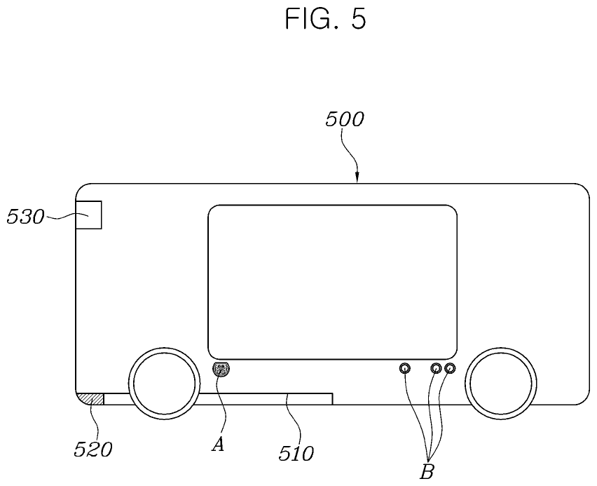

Accordingly, as shown in FIG. 5, the mobility vehicle 500 may be disposed with a charging terminal A for receiving power and ports B for fluid exchange.

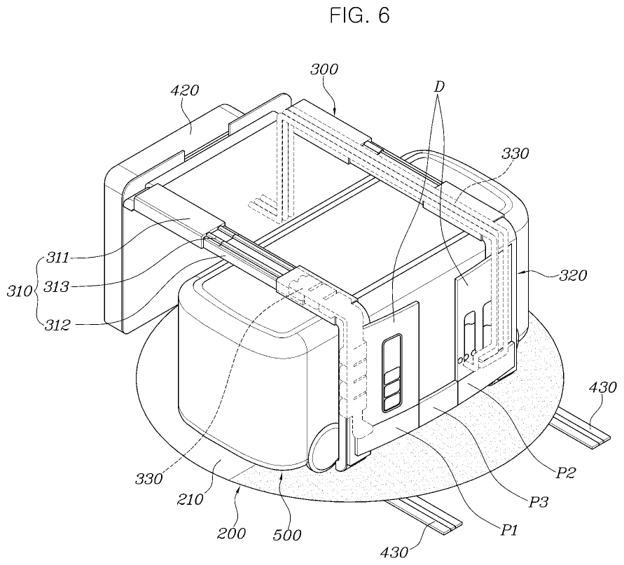

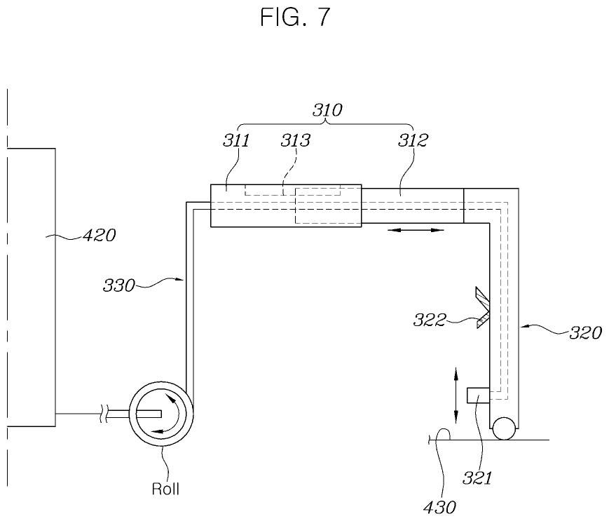

Additionally, as shown in FIGS. 6 and 7, the charger 300 may include a supply line 330 for transmitting power or fluid from the supply module 420, and a connector 321 for power transmission or fluid exchange that connect to the supply line 330.

This setup allows, when the mobility vehicle 500 enters the charging area 400 and the charger 300 docks with the mobility vehicle 500, the connector 321 of the charger 300 to connect to the charging terminal A and ports B of the mobility vehicle 500, enabling the supply of power from the supply module 420 to the mobility vehicle 500 or the exchange of fluids between the supply module 420 and the mobility vehicle 500.

Moreover, the charger 300 may include a display D that shows various information, such as the battery charge level, coolant charge level, drinking water charge level, and wastewater treatment rate.

The charging terminal A and ports B of the mobility vehicle 500, and the connectors 321 of the charger 300, connected thereto are merely exemplary embodiments of the disclosure and may be applied in various embodiments depending on the services disposed to the mobility vehicle 500 through the supply module 420.

According to an exemplary embodiment of the present disclosure of the disclosure, the charger 300 may include a movable member 310 and a docking member 320.

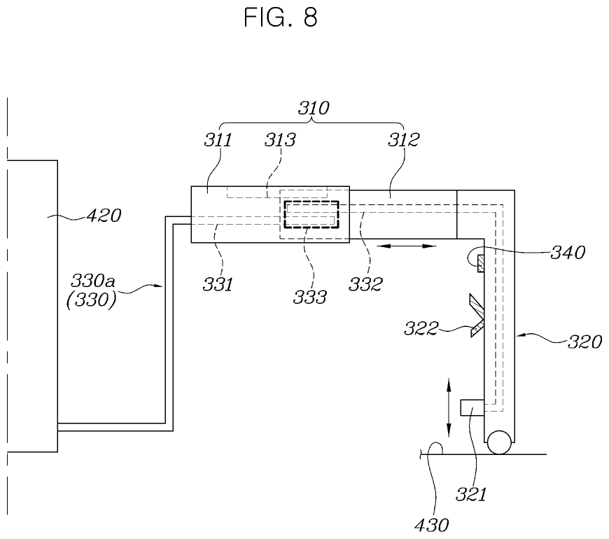

FIG. 7 illustrates the charger 300 according to one embodiment, and FIG. 8 illustrates the charger 300 according to another embodiment.

The movable member 310 may has a variable length through a sliding motion within the structure 410, allowing the docking member 320 to move to or away from the charging position depending on the length adjustment of the movable member 310. The movable member 310 may operate to vary its length in the direction toward the structure 410, enabling the docking member 320 to move to the charging position and dock with the mobility vehicle 500 when the length of the movable member 310 decreases, or to move away from the charging position and undock from the mobility vehicle 500 when the length of the movable member 310 increases.

The docking member 320 is connected to the movable member 310, moves along with the docking member 320, and includes a connector 321 that docks with the mobility vehicle 500 when moved to the charging position.

The connector 321 is configured to connect to the charging terminal A or ports B of the mobility vehicle 500, allowing power or fluid provided by the supply module 420 to be delivered to the mobility vehicle 500 via the supply line 330 when the connector 321 is connected to the mobility vehicle 500. The connector 321 may be provided in plural depending on the number or type of charging terminal A or ports B on the mobility vehicle 500.

Furthermore, the connector 321 may be designed for multi-directional position adjustment on the docking member 320.

For example, the connector 321 may be connected to a robotic arm or changed in position vertically and horizontally via actuator control. The present capability of the connector 321 to adjust its position on the docking member 320 allows the connector 321 to track and connect to the charging terminal A or ports B of the mobility vehicle 500, which has been aligned to the charging position through the securing means 200.

As shown in FIGS. 6 and 7, a guide rail 430 is disposed on the floor of the charging area 400, and the docking member 320 is seated on the guide rail 430, allowing the docking member 320 to move stably along the guide rail 430 while being supported during the length adjustment operation of the movable member 310.

To facilitate this, the docking member 320 may include rollers for rolling movement along the guide rail 430 or a low-friction structure for sliding movement at the bottom thereof.

The guide rail 430 may extend from the charging area to the support plate 210. As a result, the docking member 320 moves steadily toward the support plate 210 while seated on the guide rail 430, and when it enters the support plate 210, the docking member 320 slides or rolls on the support plate 210 to connect with the mobility vehicle 500. A portion of the support plate 210 may be constructed with a low-friction structure to allow the docking member 320 to roll or slide.

In the present way, the docking member 320 is seated on the guide rail 430 outside the support plate 210, ensuring linear motion and structural stability, and as the docking member 320 moves along the guide rail 430 and enters the support plate 210, the connector 321 connects to the mobility vehicle 500 to perform power charging or fluid exchange.

In an exemplary embodiment of the present disclosure, the docking member 320 is configured to move in a direction away from or toward the structure 410 through the length-variable operation of the movable member 310, allowing it to selectively connect to the mobility vehicle 500, and thus, the guide rail 430 may be formed to extend in the direction toward the structure 410.

Meanwhile, the movable members 310 are provided in plural and provided to be movable in the structure 410, with the spacing between each movable member 310 adjustable, and the docking member 320 is connected to the plural movable members 310, with each movable member 310 being configured to have a variable length in the direction of movement.

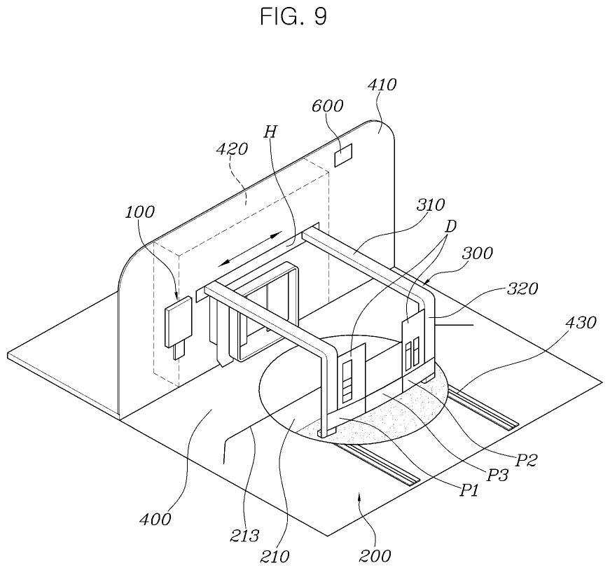

As shown in FIG. 9, the movable members 310 may be configured as a pair on the structure 410, with each movable member 310 disposed to move towards or away from the structure 410. In conjunction with this, the docking member 320 may have a variable length in the direction of movement of the movable members 310, depending on the movement position of each movable member 310.

For example, the docking member 320 may be composed of a plurality of portions, P1, P2, and P3, connected to each movable member 310, with each portion being slidably connected in an insertion structure, allowing the portions to move and alter the length by either shortening or extending based on the positions of the movable members 310. With reference to FIG. 6, the first portion P1 is connected to one of the movable members 310 and moves together with it, the second portion P2 is connected to the other movable member 310 and moves together with it, and the third portion P3 is disposed between the first portion P1 and the second portion P2, allowing the first portion P1 and the second portion P2 to slide relative to the third portion P3. Through this, the docking member 320 may perform a length-variable operation in the direction of movement of each movable member 310.

Additionally, each portion of the docking member 320 includes different connectors 321, and the position of each connector 321 may change depending on the position of the movable members 310.

For example, the first portion P1 may be provided with a connector 321 that connects to the charging terminal A of the mobility vehicle 500, and the second portion P2 may be provided with a connector 321 that connects to the ports B of the mobility vehicle 500, allowing the positions of the first portion P1 and second portion P2 to shift with the movement of the movable members 310, altering the positions of the connectors 321 provided in each portion. This allows the connectors 321 to be configured for connection to various mobilities 500.

In an exemplary embodiment of the present disclosure, to enable the movement of the movable member 310 within the structure 410, a hole H extending in a straight line may be formed in the structure 410, allowing each movable member 310 to have its position altered by a motor or actuator disposed in the structure 410.

The number of movable members 310 may vary beyond the pair described in the above embodiment.

The movable member 310 may include a fixed portion 311 disposed on the structure 410, a sliding portion 312 that slides within the fixed portion 311, and a driving portion 313 disposed on the fixed portion 311 and connected to the sliding portion 312 to move the sliding portion 312.

With reference to FIG. 7, the movable member 310 includes a fixed portion 311, a sliding portion 312, and a driving portion 313.

The fixed portion 311 may be disposed in the structure 410 to be movable, and the sliding portion 312 may be inserted into the fixed portion 311, allowing it to slide within the fixed portion 311. The fixed portion 311 and the sliding portion 312 may be interconnected through a low-friction material or a bearing structure.

This allows the sliding portion 312 to slide within the fixed portion 311, and depending on the distance the sliding portion 312 is extended or retracted, the overall length of the movable member 310 changes, shifting the position of the docking member 320 coupled to the sliding portion 312.

The driving portion 313 is disposed in the fixed portion 311 and is connected to the sliding portion 312 to control the movement of the sliding portion 312. The driving portion 313 may be a linear actuator, a motor with a gear connection structure, a rack and pinion mechanism, or other structures that allow the sliding portion 312 to move linearly as the driving portion 313 operates.

Meanwhile, the docking member 320 may include a jig portion 322 that contacts and supports the external surface of the mobility vehicle 500 when moving to the charging position.

As shown in FIG. 7, the jig portion 322 is disposed in the direction of the mobility vehicle 500 on the docking member 320, and when the docking member 320 moves toward the mobility vehicle 500, the jig portion 322 contacts with the external surface of the mobility vehicle 500 to form a support structure. The jig portion 322 may be positioned at the topmost or outermost portion to avoid vulnerable areas, including the connection area of the connector 321 or the glass of the mobility vehicle 500.

Additionally, the jig portion 322 may be configured for surface-contact with the mobility vehicle 500, and a shock-absorbing member may be applied to prevent damage to the mobility vehicle 500 upon contact.

The number, shape, and position of the jig portion 322 may vary depending on the design. Furthermore, the jig portion 322 may be configured to be movable on the docking member 320, allowing it to securely support the mobility vehicle 500 while avoiding damage by contacting with the areas that need protection and forming a stable support structure.

Meanwhile, the supply line 330 connecting the supply module 420 and the connector 321 may be implemented in various forms.

As shown in the exemplary embodiment of FIG. 7, when the supply line 330 includes a wire or hose, it may be wound in the structure 410 for the length-variable movement of the movable member 310. That is, the supply line 330 extends from the supply module 420 and is partially wound on a roll so that even as the docking member 320 moves with the length-variable motion of the movable member 310, the supply line 330 moves along with the docking member 320, maintaining its connection to the connector 321.

As shown in the exemplary embodiment of FIG. 8, the power supply line 330a, which delivers power within the supply line 330, may be divided into a fixed line 331 and a movable line 332, with the fixed line 331 configured to extend from the structure 410 to the movable member 310, and the movable line 332 configured to move along with the docking member 320. Here, the fixed line 331 and the movable line 332 may be grounded at the fixed portion 311 of the movable member 310 and may transmit power via wireless power transfer or sliding contact.

That is, the power supply line 330a transmitting power includes a fixed line 331 extending only from the structure 410 to the movable member 310, and a movable line 332 moving along with the docking member 320, with the fixed line 331 and movable line 332 transmitting and receiving power through either a contactless method or a sliding contact method within the movable member 310.

The wireless power transfer is a contactless method where one of the fixed line 331 or movable line 332 includes a power coil, and the other with a receiving coil, allowing the power transmitted from the power source of the supply module 420 to be delivered. In other words, power may be transmitted and received through electromagnetic induction between the power coil and the receiving coil.

The sliding contact method involves a fixed contact on the fixed line 331 and a movable contact on the movable line 332, with the movable contact maintaining contact with the fixed contact during movement of the movable line 332 along with the docking member 320, sliding while maintaining the contact. This enables power transmission between the fixed line 331 and the movable line 332, delivering power from the supply module 420 to the connector 321.

The aforementioned wireless power transfer and sliding contact method are generally used structures in power transmission fields, and detailed explanations are omitted.

Thus, the power transceiver structure 333, based on power coils/receiver coils or fixed contacts/movable contacts, which enables power transmission between the fixed line 331 and the movable line 332, may be selectively applied depending on the design of the charger 300, and the power transceiver structure 333 is not limited to these and may be implemented in various forms.

Meanwhile, as shown in FIG. 4 and FIG. 8, the docking member 320 includes a sensor 340 that detects the distance between the docking member 320 and the mobility vehicle 500 entering the charging area 400, and the driving portion 313 may adjust the movement distance of the sliding portion 312 based on the distance between the docking member 320 and the mobility vehicle 500, as input thereof through the sensor 340.

The sensor 340, as a means for detecting the distance of an object, may include at least one of a laser, LiDAR, infrared, or camera, and other various means may also be selectively applied.

Thus, the sensor 340 disposed on the docking member 320 measures the distance between the docking member 320 and the mobility vehicle 500. This allows the distance the docking member 320 may move toward the mobility vehicle 500 to be derived based on the separation distance between the docking member 320 and the mobility vehicle 500, and based on the derived distance, the driving portion 313 operates to move the sliding portion 312 within the fixed portion 311, causing the docking member 320 to move toward the mobility vehicle 500 and connect the connector 321 of the docking member 320 to the mobility vehicle 500.

The sensor 340 may be provided in plural, arranged at the end portions or top and bottom portion of the docking member 320, and each sensor 340 measures the distance between the docking member 320 and the mobility vehicle 500, allowing the alignment or docking status of the docking member 320 to be confirmed.

The actuator provided for the driving portion 313, the movement of the movable member 310, and the position change of the connector 321, as described above, may be implemented in various ways, including motor connection structures, gear connection structures, rack and pinion connection structures, and cylinder connection structures, and the configuration for moving components is not limited to any single structure but may be applied in various forms.

Meanwhile, the docking and charging station further includes a controller 600 that is configured to control the securing means 200 and the charger 300.

Here, the controller 600 communicates with the mobility vehicle 500 to provide authenticated mobility vehicle information to the detector 100, enabling the detector 100 to verify whether the mobility vehicle 500 is authenticated based on the provided information.

That is, the controller 600 may communicate with the mobility vehicle 500 or a device carried by a passenger inside the mobility vehicle 500 through a server to verify the eligibility of the mobility vehicle 500 for entry into the charging area 400. The controller 600 may verify the eligibility of the mobility vehicle 500 for entry into the charging area 400 based on predetermined criteria such as payment status, membership registration, and identity verification.

In the present way, the controller 600 communicates with the mobility vehicle 500 to authenticate the mobility vehicle 500 and provides the authenticated mobility vehicle information to the detector 100, allowing the detector 100 to detect the authenticated mobility vehicle 500 and confirm its entry into the charging area 400.

Meanwhile, the controller 600 may be configured for controlling the securing means 200 upon entry of the mobility vehicle 500, adjusting the position of the mobility vehicle 500 to the charging position, and may communicate with the mobility vehicle 500 to ensure that the mobility vehicle 500 remains stationary.

That is, when the mobility vehicle 500 enters the charging area 400 and settles on the securing means 200, the controller 600 is configured to control the securing means 200 to align the mobility vehicle 500 to the charging position. Here, the alignment of the mobility vehicle 500 to the charging position is determined based on factors such as the entry direction, position, type, and status of the mobility vehicle 500, and the securing means 200 is controlled to align the mobility vehicle 500 to the determined charging position.

Additionally, the controller 600 ensures that the mobility vehicle 500 remains stationary upon entry into the securing means 200. That is, upon entry into the charging area 400, the mobility vehicle 500 is controlled by the controller 600, which forces the mobility vehicle 500 to remain stationary during charging, preventing damage or accidents to various equipment caused by the mobility vehicle 500 operating during power or fluid charging.

Meanwhile, the controller 600 may move the charger 300 out of the charging position when a passenger enters or exits the mobility vehicle 500.

That is, the charger 300, when present in the charging position while a passenger enters or exits the mobility vehicle 500, may obstruct the passenger's path and hinder movement. When the charger 300 moves while a passenger is inside the charging area, the passenger may get caught between the mobility vehicle 500 and the charger 300, or collide with the charger 300, potentially causing injury.

Therefore, the controller 600 prevents the charger 300 from entering the charging position when a passenger is boarding or alighting from the mobility vehicle 500, preventing safety accidents, and allows the charger 300 to move to the charging position when no passengers are present in the charging area 400, including the mobility vehicle 500, so that the mobility vehicle 500 may be charged.

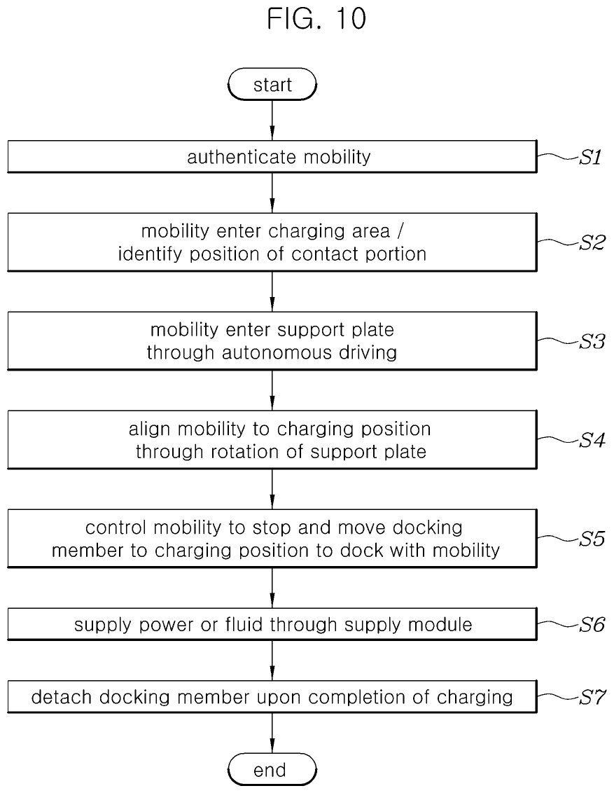

The control operation of the controller 600 for adjusting the charging position and performing power and fluid charging for the mobility vehicle 500 may be carried out in the order of control operations S1, S2, S3, S4, S5, S6 and S7 as shown in FIG. 10.

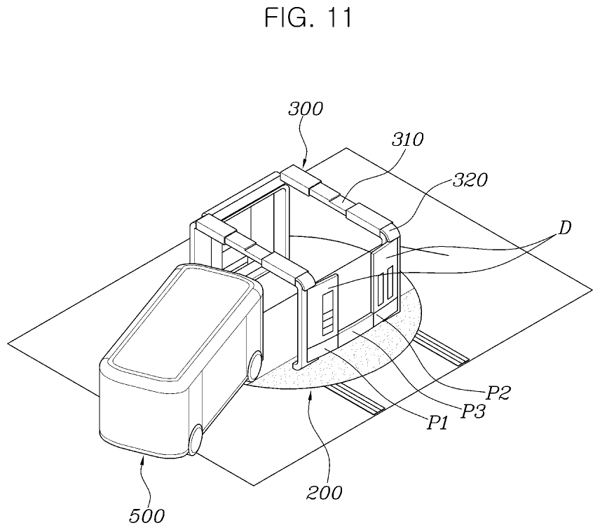

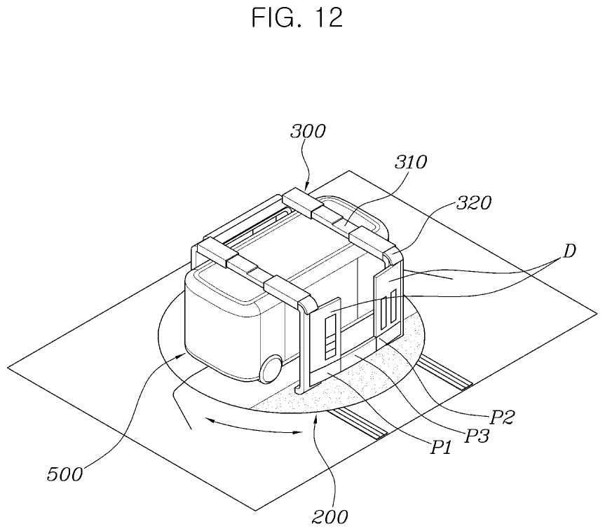

That is, as shown in FIG. 11, when the mobility vehicle 500 enters the charging area 400, the detector 100 verifies the mobility vehicle 500 and grants access, and as shown in FIG. 12, once the mobility vehicle 500 enters the charging area 400 and rests on the support plate 210, the securing means 200 aligns the mobility vehicle 500 to a charging-ready position.

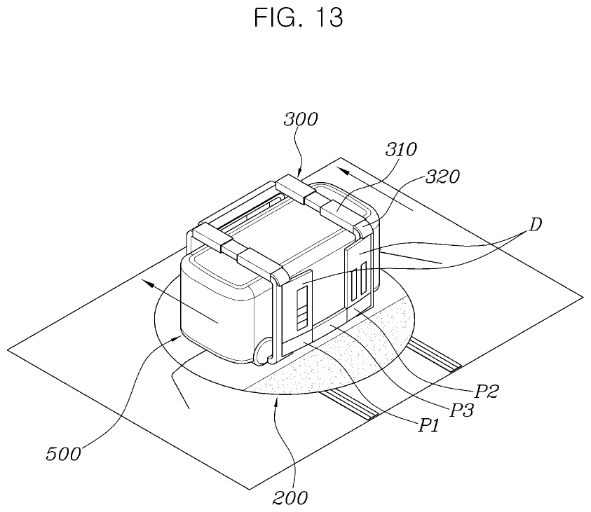

Once the mobility vehicle 500 is aligned to the charging position, as shown in FIG. 13, the docking member 320 is moved to the charging position to dock with the mobility vehicle 500, and the supply module 420 provides power or fluid, or facilitates fluid exchange.

Once the charging or exchange process of the mobility vehicle 500 is completed, the docking member 320 detaches from the mobility vehicle 500, allowing the mobility vehicle 500 to exit the charging area 400.

The docking and charging station, structured as described above, reduces the inconvenience caused by waiting for charging by pre-authorizing the use of the station for charging through an authentication procedure before charging an electric mobility vehicle 500.

Additionally, easy access to the charging location and the automated alignment of the electric mobility vehicle 500 eliminate the inconvenience of having to precisely move the electric mobility vehicle 500 to the charging position.

Furthermore, the automation of both power charging and fluid supply ensures charging convenience for electric mobility vehicle 500.

Although the disclosure has been illustrated and described in connection with specific embodiments, it will be obvious to those skilled in the art that various modification and changes may be made thereto without departing from the spirit of the disclosure or the scope of the appended claims.

What is claimed is:

1. A docking and charging station comprising:
a detector configured to detect a mobility vehicle entering a charging area of the docking and charging station;
a securing means disposed in the charging area and configured to adjust a position of the mobility vehicle detected by the detector to a charging position based on that the mobility vehicle enters the charging area; and
a charger disposed to be movable within the charging area and configured, upon moving to the charging position, to dock with the mobility vehicle adjusted in position by the securing means to provide at least one of power or fluid to the mobility vehicle or to exchange the at least one with the mobility vehicle.

2. The docking and charging station of claim 1, wherein the detector is configured to collect at least one of authentication status information, battery information, and status information of the mobility vehicle.

3. The docking and charging station of claim 1, wherein the securing means comprises a support plate rotatably disposed on a floor of the charging area and configured to seat the mobility vehicle.

4. The docking and charging station of claim 3,
wherein the support plate comprises a contact portion disposed at a center portion of the support plate so that upon the mobility vehicle entering the support plate, a connection portion of the mobility vehicle disposed at a lower portion of the mobility vehicle is configured to contact with the contact portion and the connection portion of the mobility vehicle is guided by contacting with the contact portion to align the mobility vehicle to the center portion of the support plate.

5. The docking and charging station of claim 1, wherein the charging area comprises a structure disposed with a supply module configured to provide or exchange at least one of power or fluid, and the charger is movably disposed on the structure.

6. The docking and charging station of claim 5, wherein the charger comprises:
a movable member; and
a docking member, the movable member having a variable length through a sliding motion within the structure, and the docking member being connected to the movable member and moving therewith,
wherein the docking member includes a connector configured to dock with the mobility vehicle while moving to the charging position.

7. The docking and charging station of claim 6, wherein the charging area comprises a guide rail disposed on a floor of the charging area, and the docking member is seated on the guide rail and moves along the guide rail.

8. The docking and charging station of claim 6, wherein the movable member is in plural and disposed to move within the structure, with spacing between the movable members being adjustable, and the docking member is connected to the plurality of movable members, with each of the movable members having a variable length in a direction of movement thereof.

9. The docking and charging station of claim 6, wherein the connector is adjustable in position in a plurality of directions on the docking member.

10. The docking and charging station of claim 6, wherein the docking member includes a jig portion configured to contact and support an exterior of the mobility vehicle moving to the charging position.

11. The docking and charging station of claim 6, wherein the charger is connected to the supply module to deliver at least one of power or fluid, and further comprises a supply line extending along the movable member and the docking member to connect with the connector.

12. The docking and charging station of claim 11, wherein the supply line comprises a power supply line including a fixed line and a movable line, the fixed line being disposed to extend from the structure to the movable member, the movable line being disposed to move with the docking member, and the fixed line and the movable line being grounded at the movable member to transmit power via wireless power transfer or sliding contact.

13. The docking and charging station of claim 6, wherein the movable member comprises a fixed portion disposed on the structure and a sliding portion slidably connected to the fixed portion, with the docking member being connected to the sliding portion, and the fixed portion includes a driving portion connected to the sliding portion to move the sliding portion.

14. The docking and charging station of claim 13,
wherein the docking member includes a sensor configured to detect a distance between the docking member and the mobility vehicle entering the charging area, and
wherein the driving portion adjusts a movement distance of the sliding portion based on a distance between the docking member and the mobility vehicle, as input thereof by the sensor.

15. The docking and charging station of claim 1, further comprising a controller configured to control the securing means and the charger, wherein the controller communicates with the mobility vehicle to provide authenticated mobility vehicle information to the detector, and the detector verifies the authenticated mobility vehicle based on the provided information.

16. The docking and charging station of claim 15, wherein the controller is further configured to control the securing means to adjust the position of the mobility vehicle to the charging position upon the mobility vehicle entering the securing means, and communicates with the mobility vehicle to control the mobility vehicle to remain stationary.

17. The docking and charging station of claim 15,
wherein the controller is further configured to control the charger to move out of the charging position when a passenger enters or exits the mobility vehicle.

18. A docking and charging system comprising:
the docking and charging station of claim 1, wherein the securing means includes a support plate rotatably disposed on a floor of the charging area and configured to seat the mobility vehicle and the support plate includes a contact portion disposed at a center portion of the support plate; and
the mobility vehicle including a connection portion extending from an edge portion toward the center portion on a bottom portion of the mobility vehicle with a narrowing width, and upon the mobility vehicle entering the support plate, comes into contact with the contact portion, and guides the mobility vehicle to the center portion of the support plate.

19. The docking and charging system of claim 18, wherein the mobility vehicle comprises a door disposed at an entrance of the connection portion, the door being configured to open upon the mobility vehicle entering the securing means.

20. The docking and charging system of claim 18, wherein the mobility vehicle detects a position of the contact portion via a sensor disposed in the mobility vehicle and moves to enter the securing means, with the connection portion facing toward the contact portion.
